(19) United States
(12) Patent Application Publication
(10) Pub. No.: US 2014/0140487 A1
(43) Pub. Date: May 22, 2014

(54) AMORPHOUS CARBON AND ALUMINUM X-RAY WINDOW

(71) Applicants: Brigham Young University, (US); Moxtek, Inc., (US)

(72) Inventors: Mallorie Harker, Springville, UT (US); Steven D. Liddiard, Springville, UT (US); Jonathan Abbot, Saratoga Springs, UT (US); Robert Davis, Provo, UT (US); Richard Vanfleet, Provo, UT (US); Lei Pei, Provo, UT (US)

(73) Assignees: Moxtek, Inc., Orem, UT (US); Brigham Young University, Provo, UT (US)

(21) Appl. No.: 13/855,580

(22) Filed: Apr. 2, 2013

Related U.S. Application Data
(60) Provisional application No. 61/663,173, filed on Jun. 22, 2012.
(60) Provisional application No. 61/655,764, filed on Jun. 5, 2012.

(51) Int. Cl. G21K 1/00

(52) U.S. Cl. CPC G21K 1/00
USPC 378/161

(57) ABSTRACT

An x-ray window including at least one aluminum layer and at least one amorphous carbon layer. At least one polymer layer may also be included. Aluminum layer(s) can provide improved gas impermeability to the window. Amorphous carbon layer(s) can provide corrosion resistance. Polymer layer(s) can provide improved structural strength.

### CLAIM OF PRIORITY

Priority is claimed to U.S. Provisional Patent Application Ser. Nos. 61/663,173, filed on Jun. 22, 2012; and 61/655,764, filed on Jun. 5, 2012; which are hereby incorporated herein by reference in their entirety.

### FIELD OF THE INVENTION

The present application is related generally to x-ray windows.

### BACKGROUND

X-ray windows can be used for enclosing an x-ray source or detection device. The window can be used to separate ambient air from a vacuum within the enclosure while allowing passage of x-rays through the window.

X-ray windows can be made of a thin film. It can be desirable to minimize attenuation of the x-rays (especially with low energy x-rays), thus it can be desirable that the film is made of a material and thickness that will result in minimal attenuation of the x-rays. Thinner films attenuate x-rays less than thick films. The film cannot be too thin;

however, or the film may sag or break. A sagging film can result in cracking of corrosion resistant coatings. A broken film can allow air to enter the enclosure, often destroying the functionality of the device. Thus it can be desirable to have a film that is made of a material that will have sufficient strength to avoid breaking or sagging, but also as thin as possible for minimizing attenuation of x-rays.

X-ray windows are often used with x-ray detectors. In order to avoid contamination of an x-ray spectra from a sample being measured, it can be desirable that x-rays impinging on the x-ray detector are only emitted from the source to be measured. Unfortunately, x-ray windows can also fluoresce and thus emit x-rays that can cause contamination lines in the x-ray spectra. Contamination of the x-ray spectra caused by low atomic number elements is usually less problematic than contamination caused by higher atomic number elements. It can be desirable therefore that the window and support structure be made of materials with as low of an atomic number as possible in order to minimize this noise.

Information relevant to attempts to address these problems can be found in U.S. Pat. No. 5,090,046.

### SUMMARY

It has been recognized that it would be advantageous to have an x-ray window that is strong, minimizes attenuation of x-rays, and minimizes x-ray spectra contamination. The present invention is directed to an x-ray window that satisfies these needs.

In one embodiment, the x-ray window includes an aluminum layer disposed between a first amorphous carbon layer and a second amorphous carbon layer. In another embodiment, the x-ray window includes a stack of thin film layers including an aluminum layer, a polymer layer, and an amorphous carbon layer. The above embodiments can be hermetically sealed to an enclosure having a hollow center. The amorphous carbon layer can be disposed as the farthest layer away from the hollow center.

### BRIEF DESCRIPTION OF THE DRAWINGS

FIG. 1 is a schematic cross-sectional side view of an x-ray window including three layers of material, in accordance with an embodiment of the present invention;

FIG. 2 is a schematic cross-sectional side view of an x-ray window including an amorphous carbon layer 23, two aluminum layers 21a-b, and a polymer layer 22, in accordance with an embodiment of the present invention;

FIG. 3 is a schematic cross-sectional side view of an x-ray window including two amorphous carbon layers 23a-b, two aluminum layers 21a-b, and a polymer layer 22, in accordance with an embodiment of the present invention;

FIG. 4 is a schematic cross-sectional side view of an x-ray window including two amorphous carbon layers 23a-b, two aluminum layers 21a-b, and a polymer layer 22, in accordance with an embodiment of the present invention;

FIG. 5 is a schematic cross-sectional side view of an x-ray window including an amorphous carbon layer 23 disposed between a polymer layer 22 and an aluminum layer 21, in accordance with an embodiment of the present invention;

FIG. 6 is a schematic cross-sectional side view of an x-ray window including an aluminum layer 21 disposed between a polymer layer 22 and an amorphous carbon layer 23, in accordance with an embodiment of the present invention;

FIG. 7 is a schematic cross-sectional side view of an x-ray window including an aluminum layer 21 disposed between two amorphous carbon layers 23a-b, in accordance with an embodiment of the present invention;

FIG. 8 is a schematic cross-sectional side view of an x-ray window 80 hermetically sealed to an opening of an enclosure 83 having a hollow center, in accordance with an embodiment of the present invention.

### DEFINITIONS

As used herein, the term amorphous carbon means an allotrope of carbon that lacks crystalline structure and includes both sp3 (tetrahedral or diamond-like) bonds and sp2 (trigonal or graphitic) bonds.

Hydrogenated amorphous carbon means an amorphous carbon in which some of the carbon atoms are bonded to hydrogen atoms.

### DETAILED DESCRIPTION

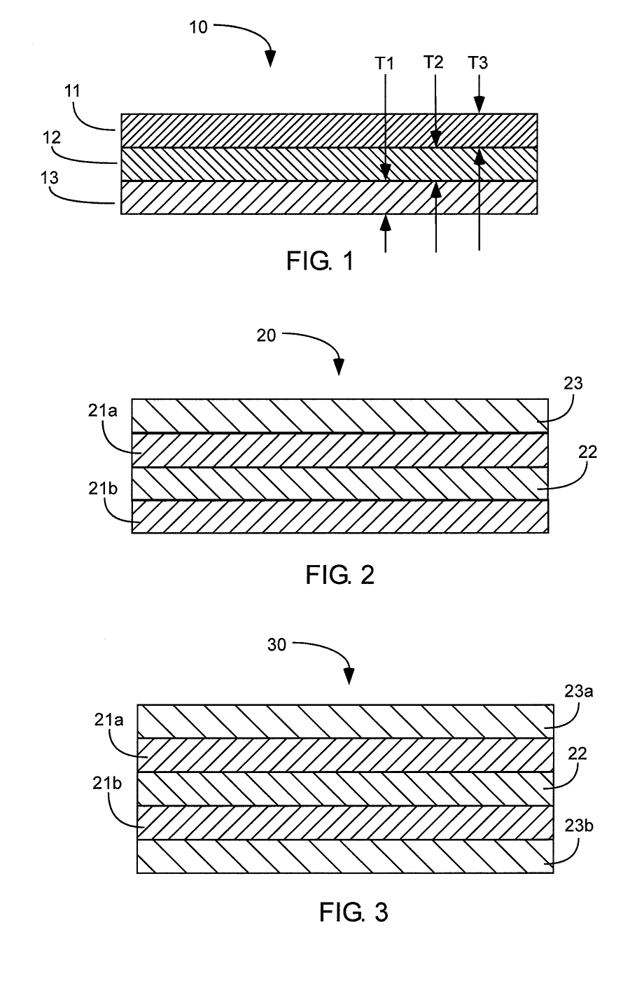

As illustrated in FIG. 1, an x-ray window 10 is shown comprising a stack of at least three layers 11-13 of material. The layers 11-13 can include at least one aluminum layer, at least one amorphous carbon layer, and/or at least one polymer layer. The layers can each have a thickness T1-3.

Use of polymer layer(s) can be beneficial for providing structural strength to the window. Aluminum layer(s) can provide improved gas impermeability to the window. Amorphous carbon layer(s) can provide corrosion resistance. These materials have fairly low atomic numbers, thus minimizing x-ray spectra contamination.

The aluminum layer(s) can be substantially pure aluminum, or can include other elements. For example, a mass percent of aluminum in the aluminum layer(s) can be at least 80% in one embodiment, at least 95% in another embodiment, or at least 99% in another embodiment. In the various embodiments described herein, the aluminum layer(s) can have various thicknesses. For example, the aluminum layer(s) can have a thickness of between 10 to 30 nanometers in one embodiment, or a thickness of between 10 to 60 nanometers in another embodiment.

The amorphous carbon layer(s) can comprise only carbon, or substantially only carbon, in one embodiment. The amorphous carbon layer(s) can have various percentages of carbon. For example, a mass percent of carbon in the amorphous carbon layer(s) can be at least 80% in one embodiment, at least 95% in another embodiment, or at least 99% in another embodiment.

Hybridization of carbon in the amorphous carbon layer(s) can include both sp3 hybridization and sp2 hybridization in various relative percentages. For example, the percent sp3 hybridization can be between 5% and 25% in one embodiment, between 15% and 25% in another embodiment, between 5% and 15% in another embodiment, or less than 25% in another embodiment. The percent sp2 hybridization can be between 75% and 95% in one embodiment, between 85% and 95% in another embodiment, between 85% and 95% in another embodiment, or greater than 75% in another embodiment.

The amorphous carbon layer(s) can be hydrogenated amorphous carbon layer(s) in another embodiment. Hydrogen inside the amorphous carbon matrix can help to stabilize the sp3 carbon atoms and can improve the cohesiveness of the layer. There can be many different percentages of atomic percent of hydrogen in the hydrogenated amorphous carbon layer. For example, an atomic percent of hydrogen in the hydrogenated amorphous carbon layer can be between 50% and 70% in one embodiment, between 25% and 51% in another embodiment, between 14% and 26% in another embodiment, between 5% and 15% in another embodiment, between 1% and 10% in another embodiment, or between 0.1% and 2% in another embodiment.

The amorphous carbon layers can have various thicknesses. For example, the amorphous carbon layer(s), including hydrogenated amorphous carbon layer(s), can have a thickness of between 5 to 25 nanometers in one embodiment, or a thickness of between 1 to 25 nanometers in another embodiment.

The polymer layer(s) can have various mass percentages of polymer. For example, a mass percent of polymer in the polymer layer(s) can be at least 80% in one embodiment, at least 95% in another embodiment, or at least 99% in another embodiment. The term “mass percent of polymer” means percent by mass in the layer that are elements of the polymer selected, such as carbon and hydrogen, and possibly other elements, depending on the polymer selected. The polymer layer can consist of only polymer in one embodiment, or can include other elements or molecules in another embodiment.

The polymer layer(s) can have various thicknesses. For example, and the polymer layer can have a thickness of between 150 to 300 nanometers.

The polymer can be or can include a polyimide. Polyimide can be useful due to its high strength and high temperature resistance as compared with many other polymers.

As illustrated in FIG. 2, an x-ray window 20 is shown comprising a stack of thin film layers including a first aluminum layer 21a, a second aluminum layer 21b, a polymer layer 22, and an amorphous carbon layer 23. An order of the stack of thin film layers is the amorphous carbon layer 23, the first aluminum layer 21a, the polymer layer 22, then the second aluminum layer 21b. In other words, the first aluminum layer 21a and the polymer layer 22 are disposed between the amorphous carbon layer 23 and the second aluminum layer 21b and the polymer layer 22 is disposed between the two aluminum layers 21a-b. The polymer layer 22 can provide structural support. The two aluminum layers 21a-b, which sandwich the polymer layer 22, can help provide gas impermeability. The amorphous carbon layer 23 can provide corrosion protection to the first aluminum layer 21a.

As illustrated in FIG. 3, an x-ray window 30 is shown comprising a stack of thin film layers including a first aluminum layer 21a, a second aluminum layer 21b, a polymer layer 22, a first amorphous carbon layer 23a, and a second amorphous carbon layer 23b. An order of the stack of thin film layers is the first amorphous carbon layer 23a, the first aluminum layer 21a, the polymer layer 22, the second aluminum layer 21b, then the second amorphous carbon layer 23b. In other words, the polymer layer 22 is disposed between the two aluminum layers 21a-b. The polymer layer 22 and the two aluminum layers 21a-b are disposed between two amorphous carbon layers 23a-b. The polymer layer can 22 provide structural support. The two aluminum layers 21a-b, which sandwich the polymer layer 22, can help provide gas impermeability. The amorphous carbon layers 23a-b can provide corrosion protection to the aluminum layers 21a-b. Selection of the x-ray window 20 of FIG. 2 or the x-ray window 30 of FIG. 3 may be made based on whether there is a need for corrosion protection of both aluminum layers 21a-b, manufacturability, cost considerations, and the amount of x-ray attenuation caused by the second amorphous carbon layer 23b.

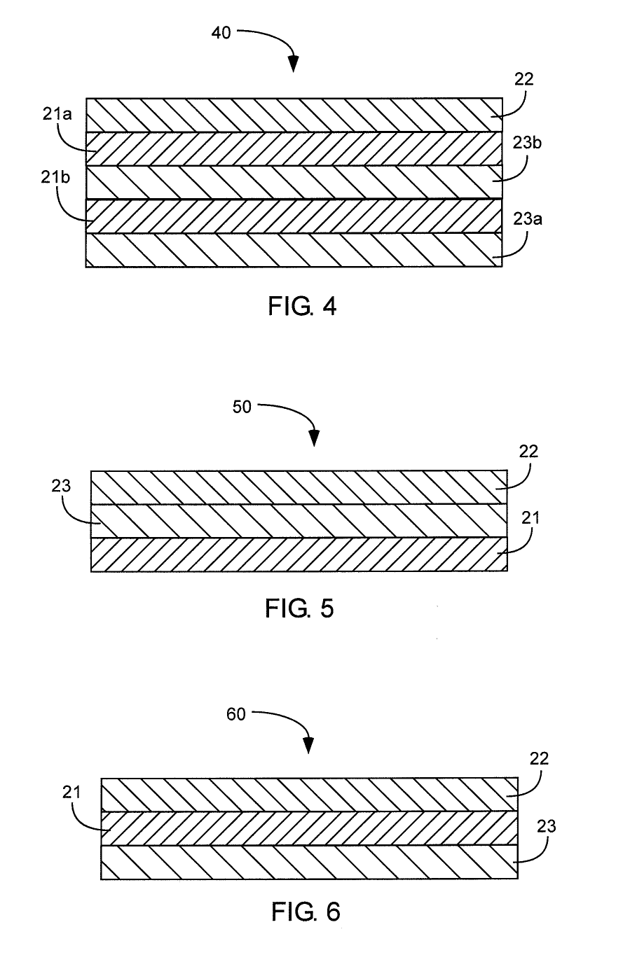

As illustrated in FIG. 4, an x-ray window 40 is shown comprising a stack of thin film layers including a first aluminum layer 21a, a second aluminum layer 21b, a polymer layer 22, a first amorphous carbon layer 23a, and a second amorphous carbon layer 23b. An order of the stack of thin film layers is the polymer layer 22, the first aluminum layer 21a, the second amorphous carbon layer 23b, the second aluminum layer 21b, then first amorphous carbon layer 23a. In other words, the second amorphous carbon layer 23b is disposed between the two aluminum layers 21a-b. The second amorphous carbon layer 23b and the two aluminum layers 21a-b are disposed between the polymer layer 22 and the first amorphous carbon layer 23a. The polymer layer can 22 provide structural support. The two aluminum layers 21a-b can help provide gas impermeability. The amorphous carbon layers 23a-b can provide corrosion protection.

As illustrated in FIG. 5, an x-ray window 50 is shown comprising a stack of thin film layers including an aluminum layer 21, a polymer layer 22, and an amorphous carbon layer 23. An order of the stack of thin film layers is the polymer layer 22, the first amorphous carbon layer 23, then the aluminum layer 21. In other words, the amorphous carbon layer 23 is disposed between the polymer layer 22 and the aluminum layer 21. This embodiment can be useful due to a small number of layers, thus minimizing x-ray attenuation, allowing ease of manufacturing, and reducing cost. The aluminum layer can be protected from corrosion if the aluminum layer is disposed to face a protected environment, such as the vacuum portion of the device for example, and the polymer layer disposed towards a more corrosive environment, such as the ambient air.

As illustrated in FIG. 6, an x-ray window 60 is shown comprising a stack of thin film layers including an aluminum layer 21, a polymer layer 22, and an amorphous carbon layer 23. An order of the stack of thin film layers is the polymer layer 22, the aluminum layer 21, then the amorphous carbon layer 23. In other words, the aluminum layer 21 is disposed between the polymer layer 22 and the amorphous carbon layer 23. This embodiment can be useful due to a small number of layers, which can minimize x-ray attenuation, reduce cost, and allow ease of manufacturing. The aluminum layer 21 can improve gas impermeability of the polymer layer 22 and the amorphous carbon layer can provide corrosion protection to the aluminum layer 21.

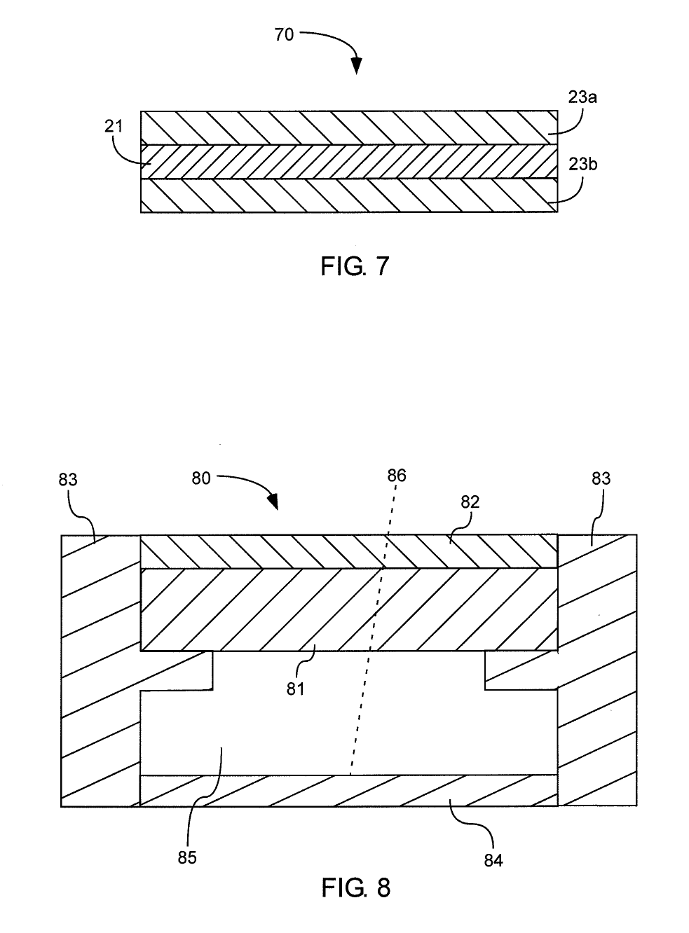

As illustrated in FIG. 7, an x-ray window 70 is shown comprising a stack of thin film layers including an aluminum layer 21, a first amorphous carbon layer 23a, and a second amorphous carbon layer 23b. An order of the stack of thin film layers is the first amorphous carbon layer 23a, the aluminum layer 21, then the second amorphous carbon layer 23b. In other words, the aluminum layer 21 is disposed between the two amorphous carbon layers 23a-b. This embodiment can be useful due to a small number of layers, which can minimize x-ray attenuation, allow ease of manufacturing, and reduce cost. The aluminum layer can improve strength and gas impermeability. The amorphous carbon layers 23a-b can provide corrosion protection to the aluminum layer 21.

As illustrated in FIG. 8, an x-ray window comprising a stack of thin film layers 80, according to one of the embodiments described herein, can be hermetically sealed to an opening of an enclosure 83. The enclosure 83 can include a hollow center 85. The stack of thin film layers 80 can include inner layer 81 and an outer layer 82. The inner layer 81 can include at least two layers of different materials. The outer layer 82 can be disposed as the farthest layer away from the hollow center 85. The outer layer 82 can be an amorphous carbon layer 23. Use of an amorphous carbon layer 23 as the outer layer 82 can allow the amorphous carbon layer 23 to provide corrosion protection to the inner layer 81. X-rays 86 can penetrate the window and enter the enclosure 83. The x-rays can impinge on an x-ray detector 84.

The enclosure 83 can be made of various materials, but titanium may be preferable due to a good match of the film's coefficient of thermal expansion and titanium's coefficient of thermal expansion. The titanium can be substantially pure titanium, with minimal other elements, in one embodiment. Alternatively, the titanium can include a certain percent of other elements. For example, the titanium can have a mass percent of greater than 99% in one embodiment, greater than 90% in another embodiment, or less or equal to 90% in another embodiment. The film 80 may be attached to the enclosure 83 by an adhesive, such as an epoxy.

The inner layer 81 can be a polymer layer 22 disposed between two aluminum layers 21a-b, as shown in FIG. 2. The inner layer 81 can be a polymer layer 22 disposed between two aluminum layers 21a-b, and a second amorphous carbon layer 23b disposed as the innermost layer, as shown in FIG. 3. The inner layer 81 can be a second amorphous carbon layer 23b disposed between two aluminum layers 21a-b, and a polymer layer 22 disposed as the innermost layer, as shown in FIG. 4. The inner layer 81 can be a polymer layer 22 and an aluminum layer 21, as shown in FIG. 6. The outer layer 82 can be a first amorphous carbon layer 23b and the inner layer 81 can be an aluminum layer 21 and a second amorphous carbon layer 23b, with the aluminum layer disposed between the two amorphous carbon layers 23ab, as shown in FIG. 7. Selection of the innermost layer can depend on the effect of this innermost layer on the vacuum, such as which layer outgases the least, and on which layer can best be sealed to the device.

An alternative to amorphous carbon layer(s) is use of HMDS (hexamethyldisilazane) layer(s). HMDS is an organosilicon compound with the molecular formula [(CH3)3Si]2NH. Thus, amorphous carbon layer(s) may be replaced with HMDS layer(s) in any location in this document. Either amorphous carbon or HMDS can serve as a corrosion barrier. HMDS may be spin cast or vapor deposited. For vapor deposition, a vacuum can be used but isn't required.

### How to Make:

The aluminum layer can be evaporation deposited. The aluminum layer and/or the amorphous carbon layer can be sputter deposited. Evaporation might be selected due to lower cost. Sputter might be selected due to improved ability to control film structure and adhesion.

Amorphous carbon layers have been successfully deposited by magnetron reactive gas sputtering with the following parameters and process:
DC Power: 400 watts
Target: graphite (99.999% purity)
Pump chamber pressure down to 2.3E-5 torr
Flow Ar gas to 7 mTorr
Turn DC Power up from 50 W to 400 W for 2 minutes
Flow ethylene at Ar:ethylene 9:1 ratio and dwell for 1 minute
Open shutter for deposition. Keep the substrate plate at about 30° C. with rotation.
Close shutter and ramp down power for 2 minutes
Vent the chamber

The various amorphous carbon and aluminum window films described herein can be attached to a support structure, such as a silicon or a carbon composite support structure. The support structure can provide additional support and can allow the window film to be made thinner and/or span larger distances. The window films can be attached to support structures, such as a carbon composite support structure for example, by a suitable adhesive, such as an epoxy, cyanoacrylate, or polyurethane.

What is claimed is:

1. An x-ray window comprising:
a. a stack of thin film layers including a first aluminum layer, a second aluminum layer, a polyimide layer, and a hydrogenated amorphous carbon layer;
b. an order of the stack of thin film layers is the hydrogenated amorphous carbon layer, the first aluminum layer, the polyimide layer, then the second aluminum layer;
c. an enclosure having a hollow center and an opening;
d. the stack of thin film layers is hermetically sealed to the opening of the enclosure; and
e. the hydrogenated amorphous carbon layer is disposed as the farthest layer away from the hollow center.

2. The x-ray window of claim 1, wherein the enclosure comprises titanium.

3. The x-ray window of claim 1, wherein:
a. the polyimide layer has a thickness of between 150 to 300 nanometers;
b. the first aluminum layer has a thickness of between 10 to 30 nanometers;
c. the second aluminum layer has a thickness of between 10 to 30 nanometers; and
d. the hydrogenated amorphous carbon layer has a thickness of between 5 to 25 nanometers.

4. An x-ray window comprising a stack of thin film layers including an aluminum layer, a polymer layer, and an amorphous carbon layer.

5. The x-ray window of claim 4, wherein hybridization of carbon in the amorphous carbon layer is:
a. less than 25% sp3 hybridization; and
b. greater than 75% sp2 hybridization.

6. The x-ray window of claim 4, wherein the amorphous carbon layer is a hydrogenated amorphous carbon layer.

7. The x-ray window of claim 6, wherein an atomic percent of hydrogen in the hydrogenated amorphous carbon layer is between 1% and 10%.

8. The x-ray window of claim 4, wherein the polymer is a polyimide.

9. The x-ray window of claim 4, wherein:
a. a mass percent of aluminum in the aluminum layer is at least 95%;
b. a mass percent of polymer in the polymer layer is at least 95%;
c. a mass percent of carbon and hydrogen in the amorphous carbon layer is at least 95%.

10. The x-ray window of claim 4, wherein:
a. the amorphous carbon layer comprises a first amorphous carbon layer and a second amorphous carbon layer;
b. the aluminum layer comprises a first aluminum layer and a second aluminum layer; and
c. an order of the layers in the stack of thin film layers is the first amorphous carbon layer, the first aluminum layer, the polymer layer, the second aluminum layer, then the second amorphous carbon layer.

11. The x-ray window of claim 10, wherein:
a. the first amorphous carbon layer has a thickness of between 5 to 25 nanometers;
b. the first aluminum layer has a thickness of between 10 to 30 nanometers;
c. the polymer layer has a thickness of between 150 to 300 nanometers;
d. the second aluminum layer has a thickness of between 10 to 30 nanometers; and
e. the second amorphous carbon layer has a thickness of between 5 to 25 nanometers.

12. The x-ray window of claim 4, wherein:
a. the amorphous carbon layer comprises a first amorphous carbon layer and a second amorphous carbon layer;
b. the aluminum layer comprises a first aluminum layer and a second aluminum layer; and
c. an order of the layers in the stack of thin film layers is the polymer layer, the first aluminum layer, the first amorphous carbon layer, the second aluminum layer, then second amorphous carbon layer.

13. The x-ray window of claim 12, wherein:
a. the polymer layer has a thickness of between 150 to 300 nanometers;
b. the first aluminum layer has a thickness of between 10 to 30 nanometers;
c. the first amorphous carbon layer has a thickness of between 5 to 25 nanometers;
d. the second aluminum layer has a thickness of between 10 to 30 nanometers; and
e. the second amorphous carbon layer has a thickness of between 5 to 25 nanometers.

14. The x-ray window of claim 4, wherein an order of the layers in the stack of thin film layers is the polymer layer, the aluminum layer, then the amorphous carbon layer.

15. The x-ray window of claim 4, wherein an order of the layers in the stack of thin film layers is the polymer layer, the amorphous carbon layer, then the aluminum layer.

16. The x-ray window of claim 15, wherein:
a. the polymer layer has a thickness of between 150 to 300 nanometers;
b. the amorphous carbon layer has a thickness of between 5 to 25 nanometers; and
c. the aluminum layer has a thickness of between 10 to 30 nanometers.

17. The x-ray window of claim 4:
a. further comprising a enclosure having a hollow center and an opening, the enclosure comprising titanium;
b. wherein the stack of thin film layers is hermetically sealed to the opening of the enclosure; and
c. wherein the amorphous carbon layer is disposed as the farthest layer away from the hollow center.

18. The x-ray window of claim 4, wherein:
a. the aluminum layer comprises a first aluminum layer and a second aluminum layer; and
b. an order of the stack of thin film layers is the first aluminum layer, the polymer layer, the second aluminum layer, then the amorphous carbon layer.

19. An x-ray window comprising an aluminum layer disposed between a first amorphous carbon layer and a second amorphous carbon layer.

20. The x-ray window of claim 19, wherein:
a. the first amorphous carbon layer has a thickness of between 1 to 25 nanometers;
b. the aluminum layer has a thickness of between 10 to 60 nanometers; and
c. the second amorphous carbon layer has a thickness of between 1 to 25 nanometers.
